(19) United States
(12) Patent Application Publication
(10) Pub. No.: US 2009/0288512 A1
(43) Pub. Date: Nov. 26, 2009

(54) KNOB SECUREMENT MEANS FOR A CONTROL DEVICE

(75) Inventor: Bob Taylor, Glendale, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/125,764

(22) Filed: May 22, 2008

(51) Int. Cl. G05G 1/12; F16H 35/18

(52) U.S. Cl. 74/10 R; 74/553

(57) ABSTRACT

A control knob is secured to a device shaft means for securing a control knob to a device shaft that eliminates loosening of the control knob relative to the device shaft during rotational and push/pull directional movement of the control knob. In addition, the control knob is secured to the device shaft to provide leeway during initial securement of the control knob to the device shaft due to tolerances in a front mounting plate. The control knob includes a threaded bore and a set screw disposed therein for securing the control knob to the device shaft. An angled groove having a plurality of angled side portions is formed into a surface of an end portion of the device shaft, whereby cooperation of the set screw within the angled groove comprises adjustable securement of the control knob to the device shaft during rotation of the control knob and device shaft.

### TECHNICAL FIELD

The present invention generally relates to a knob securement assembly, and more particularly relates to a control knob and device shaft securement assembly that prevents loosening of the control knob from the device shaft during rotational and push/pull operations.

### BACKGROUND

In control panels such as those found in modern aircraft, it is common practice to mount switches and other devices having control shafts within a housing. Typically the control shafts protrude through a stationary front panel, or mounting plate, of the housing. A knob fits on the end of each shaft and is securely retained by either a spring which fits within a bore in the knob and surrounds the shaft or lever, or a set screw in the knob which presses against a flattened portion of what would otherwise be a substantially circular shaft. This type of attachment means is not suitable for knobs which must be continuously moved to switch them to a proper position. The set screw pressing against the flat portion can loosen, allowing the knob to fall off the shaft. One application of such knobs is with rotational encoders that are used continuously during flight. Current attachment methods employ a small set screw turned on to a flat surface of the encoder shaft. Initially this method will hold the knob onto the encoder shaft, but over time, rotating the knob and thus the switch back and forth during use may result in loosening of the knob relative to the encoder shaft. An additional issue with this method of attaching a knob to an encoder shaft is with switches that are pushed and pulled during their operation. A set screw tightened onto a flat surface may not secure the knob during this fore and aft, or push/pull operation.

Prior art remedies to this knob attachment issue include cutting a groove into and circumferentially about the encoder shaft. The fabrication of this type of groove into the encoder shaft may prevent loosening of the knob due to pushing and pulling, but it does not address the rotational issue. In addition, a circumferentially defined groove does not allow for adjustment with respect to alignment of the knob relative to the front panel positioned between the knob and switch assembly, and thus compensation for any tolerances in the panel thickness. Wherever the groove is formed circumferentially about the shaft, determines the in/out positioning of the knob relative to the panel. This may cause an interference of the knob with the face of the panel if positioned too close.

Therefore, there is a need for a knob assembly and means of securing a knob to a shaft that eliminates loosening of the knob relative to the shaft during rotational and push/pull directional movement of the knob. In addition, there is a need for a knob assembly and method of securing a knob to a shaft that provides some leeway during initial securement of the knob to the shaft due to tolerances in the front panel or mounting plate.

### BRIEF SUMMARY

The inventive subject matter provides a means for securing a knob to a device shaft that eliminates loosening of the knob relative to the device shaft during rotational and push/pull directional movement of the knob.

In one embodiment, and by way of example only, in a control device having a stationary front panel, an actuating device comprising a device shaft extending through an aperture in the control panel for rotation about an axis relative to the panel, and a control knob on the device shaft, the control knob including a knob securement means comprising: a threaded bore in the control knob; a set screw disposed within the threaded bore for securing the control knob to the device shaft; and an angled groove having a plurality of angled side portions formed into a surface of an end portion of the device shaft, whereby cooperation of the set screw within the angled groove comprises adjustable securement of the control knob to the device shaft during rotation of the control knob and the device shaft.

In another embodiment, and by way of example only, in a control device of an aircraft having a stationary front panel, an actuating device comprising a device shaft extending through an aperture in the control panel for rotation about an axis relative to the panel, and a control knob on the device shaft, the control knob including a knob securement means comprising: a threaded bore formed in a shank portion of the control knob; a cooperating set screw disposed within the threaded bore of the control knob for securing the control knob to the device shaft; and an angled groove having a plurality of angled side portions formed into a surface of an end portion of the device shaft, the angled groove formed into the surface at an angle between 10-80 degrees relative to a linear axis of the device shaft, whereby cooperation of the set screw within the angled groove comprises adjustable securement of the control knob to the device shaft during rotation of the control knob and device shaft.

In still another embodiment, and by way of example only, a means for securing a knob to a device shaft wherein the a device assembly comprises: an actuating device including a device shaft extending therefrom and configured for actuation of the actuating device upon movement of the device shaft rotationally about a linear axis of the device shaft or perpendicular to the linear axis of the device shaft; a control knob coupled to an end portion of the device shaft and configured to provide means for accomplishing movement of the device shaft; a means for securement of the control knob to the device shaft including an angled groove having angled side portions formed into the surface of the end portion of the device shaft and a cooperating set screw extending through a portion of the control knob, whereby the positioning of the set screw to contact the angled side portions of the angled groove comprises a securement means upon movement of the control knob and device shaft.

Other independent features and advantages of the preferred assemblies and methods will become apparent from the following detailed description, taken in conjunction with the accompanying drawings which illustrate, by way of example, the principles of the inventive subject matter.

### BRIEF DESCRIPTION OF THE DRAWINGS

The present invention will hereinafter be described in conjunction with the following drawing figures, wherein like numerals denote like elements, and

FIG. 1 is a partial sectional view of a control device of an aircraft having a control knob positioned relative to a device shaft prior to securement, the control knob including a knob securement means according to an embodiment;

FIG. 2 is a sectional view of the assembly of FIG. 1 including the control knob secured to the device shaft according to an embodiment; and

FIG. 3 is a close up view of a portion of the device shaft and the angled groove formed therein according to an embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. Furthermore, while the ensuing description is directed to a knob assembly for a control apparatus in an aircraft, it is applicable as well to other applications, both aircraft and non-aircraft, having a manually controlled device shaft which is equipped with an angled groove as described herein.

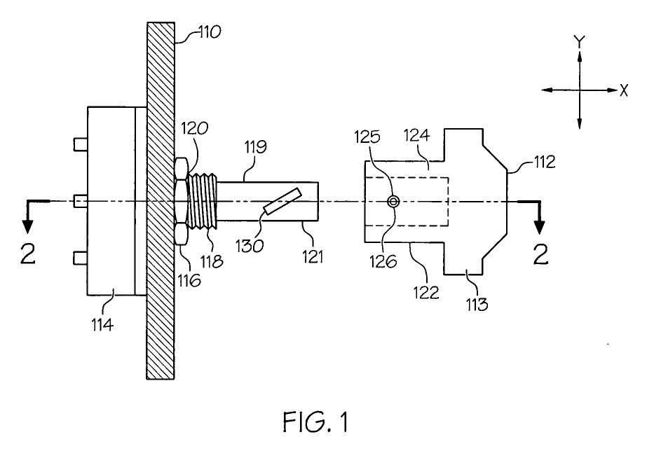

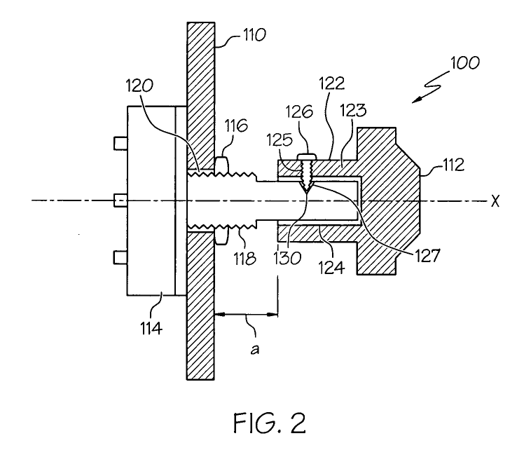

Referring now to the drawings, and in particular FIG. 1, illustrated is a partially disassembled control assembly or control device according to an embodiment, generally referenced 100. The control assembly 100 includes a stationary front mounting plate or plate 110 for supporting electronic circuitry and control switches, and the like. A control knob 112 is positioned relative to the stationary front plate 110. A sectional view through the control knob 112 and the front plate 110 in an assembled or secured state is shown in FIG. 2. An actuating device 114, such as a switch or encoder device, is mounted to the front plate 110 with a mounting bolt 116, or the like. A substantially circular device shaft 118 extending from the actuating device or encoder device 114 is positioned extending through an aperture 120 formed in the front plate 110.

In the illustrated embodiment the control knob 112 includes a shank 122 and head portion 113. Although a specific design for control knob 112 is depicted in the FIGs. it should be understood that any shape knob configured for use with the device shaft 118 is anticipated. The shank 122 includes a bore 124 formed therein and extending parallel with the linear axis of the shank 122. The bore 124 is substantially shaped to conform to the shape of the device shaft 118. A threaded bore 125 formed in a sidewall 123 of the shank 122 and substantially perpendicular to the bore 124 provides for the insertion of a set screw 126 extending through the sidewall 123 of the shank 122 and contacting the device shaft 118. The set screw 126 provides conventional retention function to secure the control knob 112 on the device shaft 118.

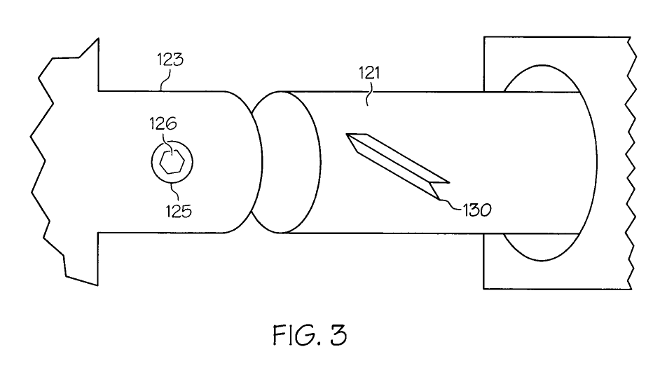

To further secure attachment of the control knob 112 to the device shaft 118, an angled groove 130 is formed in the device shaft 118. More specifically, the angled groove 130 is formed into a surface 119 of an end portion 121 of the device shaft 118 and at an angle to the linear axis, illustrated in FIG. 2. In a preferred embodiment, the angled groove 130 is formed at an angle of between 10-80 degrees relative to the linear axis of the device shaft 118, and at a preferred angle of 45 degrees relative to the linear axis of the device shaft 118. As best shown in FIG. 3, the angled groove 130 includes a plurality of angled sides 132 so as to form a substantially v-shaped groove cut into the surface of the device shaft 118. To secure the control knob 112 to the device shaft 118, the control knob 112 is positioned onto the device shaft 118, and more particularly, the device shaft 118 is inserted into the bore 124 formed in the control knob 112 whereby the set screw 126 is substantially aligned with the angled groove 130. The control knob 112 is properly positioned a distance “a” from the mounting plate 110 as illustrated in FIG. 1. Secure retention of the control knob 112 is accomplished by tightening the set screw 126 so that it engages with the angled groove 130. In a preferred embodiment, the set screw 126 may include an angled tip 127 as illustrated in FIG. 2, and more particularly angled circumferential side aspects, so that tight engagement with the angled sides 132 of the angled groove 130 is accomplished. The formation of the angled groove 130 at a relative angle to the linear axis of the device shaft 118 provides maximum retention force in both the “x” direction, when pushing or pulling the control knob 112 and in the “y” direction, when rotating the control knob 112 circumferentially about the linear axis of the device shaft 118.

A knob assembly has now been provided to that is capable of being releasably secured to a shaft without becoming loose during movement of the knob. In addition, provided is a means for adjustment of the knob relative to a mounting plate to provide for tolerances in the thickness of the mounting plate and assure a flush mount to the face of the mounting plate when desired. While the prior art has reported using knobs, none have established a basis for a specific knob securement design that is dedicated to the task of resolving the particular problem at hand.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. In a control device having a stationary front panel, an actuating device comprising a device shaft extending through an aperture in the control panel for rotation about an axis relative to the panel, and a control knob on the device shaft, the control knob including a knob securement means comprising:
a threaded bore in the control knob;
a set screw disposed within the threaded bore for securing the control knob to the device shaft; and
an angled groove having a plurality of angled side portions formed into a surface of an end portion of the device shaft, whereby cooperation of the set screw within the angled groove comprises adjustable securement of the control knob to the device shaft during rotation of the control knob and the device shaft.

2. The knob securement means of claim 1, wherein the actuating device is a switch in an aircraft.

3. The knob securement means of claim 1, wherein the device shaft is substantially circular shaped across a cross-section.

4. The knob securement means of claim 1, wherein the set screw includes a tip formed having an angled circumferential side aspect.

5. The knob securement means of claim 1, wherein the angled groove is formed at an angle between 10-80 degrees relative to the linear axis of the device shaft.

6. The knob securement means of claim 5, wherein the angled groove is formed into the surface of the device shaft at an angle of 45 degrees relative to the linear axis of the device shaft.

7. In a control device of an aircraft having a stationary front panel, an actuating device comprising a device shaft extending through an aperture in the control panel for rotation about an axis relative to the panel, and a control knob on the device shaft, the control knob including a knob securement means comprising:
a threaded bore formed in a shank portion of the control knob;
a cooperating set screw disposed within the threaded bore of the control knob for securing the control knob to the device shaft; and
an angled groove having a plurality of angled side portions formed into a surface of an end portion of the device shaft, the angled groove formed into the surface at an angle between 10-80 degrees relative to a linear axis of the device shaft, whereby cooperation of the set screw within the angled groove comprises adjustable securement of the control knob to the device shaft during rotation of the control knob and device shaft.

8. The knob securement means of claim 7, wherein the control device is a switch.

9. The knob securement means of claim 7, wherein the device shaft is substantially circular shaped across a cross-section.

10. The knob securement means of claim 7, wherein the set screw includes a tip formed having an angled circumferential side aspect.

11. The knob securement means of claim 7, wherein the angled groove is formed into the surface of the device shaft at an angle of 45 degrees relative to a linear axis of the device shaft.

12. A device assembly comprising:
an actuating device including a device shaft extending therefrom and configured for actuation of the actuating device upon movement of the device shaft rotationally about a linear axis of the device shaft or perpendicular to the linear axis of the device shaft;
a control knob coupled to an end portion of the device shaft and configured to provide means for accomplishing movement of the device shaft;
a means for securement of the control knob to the device shaft including an angled groove having angled side portions formed into the surface of the end portion of the device shaft and a cooperating set screw extending through a portion of the control knob, whereby the positioning of the set screw to contact the angled side portions of the angled groove comprises a securement means upon movement of the control knob and device shaft.

13. The assembly of claim 12, wherein the actuating device is a switch.

14. The assembly of claim 13, wherein the actuating device is an encoder in an aircraft.

15. The assembly of claim 12, wherein the device shaft is substantially circular shaped across a cross-section.

16. The assembly of claim 12, wherein the set screw includes a tip formed having an angled circumferential side aspect.

17. The assembly of claim 12, wherein the angled groove is formed at an angle between 10-80 degrees relative to the linear axis of the device shaft.

18. The assembly of claim 17, wherein the angled groove is formed into the surface of the device shaft at an angle of 45 degrees relative to the linear axis of the device shaft.

19. The assembly of claim 12, further including a mounting plate having an aperture formed therein wherein the end portion of the device shaft extends through the mounting plate.

20. The assembly of claim 12, wherein the control knob includes a shank portion having a bore formed therein conforming to the size and shape of the device shaft.
